(19) United States
(12) Patent Application Publication
(10) Pub. No.: US 2007/0150755 A1
(43) Pub. Date: Jun. 28, 2007

(54) Microcomputer, method for writing program to microcomputer, and writing system

(75) Inventors: Yoshiaki Makii, Kanagawa (JP); Toshihide Tsuboi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/645,665

(22) Filed: Dec. 27, 2006

(30) Foreign Application Priority Data
Dec. 28, 2005 (JP) 2005-377164

(51) Int. Cl. G06F 12/14

(52) U.S. Cl. 713/193

(57) ABSTRACT

A microcomputer according to the present invention includes a first non-volatile storage unit, a first input terminal configured to input first key data, a second storage unit configured to store second key data that is different from the first key data, a second input terminal configured to input an encrypted program, a decrypting unit configured to decrypt the encrypted program using the first and the second key data, and a central processing unit configured to control storing a decrypted program decrypted by the decrypting unit to the first storage unit.

### BACKGROUND OF THE INVENTION

1. Field of the Invention

The present invention relates to a microcomputer including a non-volatile memory capable of writing to a program after a chip is manufactured, and a method for writing a program to a non-volatile memory embedded in a microcomputer.

2. Description of Related Art

A microcomputer integrated into one chip having peripheral devices such as ROM (Read Only Memory) and RAM (Random Access Memory) is referred to as a Micro Controller Unit (hereinafter referred to as MCU). In a ROM (Read Only Memory) region included in the MCU, a program (hereinafter referred to as a customer program) corresponding to a controlled apparatus such as electronic equipment is written thereto. The MCU is mostly incorporated into such controlled apparatus.

Conventionally, mask ROM products for writing a customer program by a mask used in manufacturing chip at a manufacturing stage of the MCU have been used in general. However in recent years, a MCU including a non-volatile memory is increasingly becoming popular, in which the customer program can be written thereto after manufacturing a MCU package.

For such non-volatile memory embedded MCU, a writing apparatus such as a LSI tester and flash memory writer is used after completing to package as a product to write the customer program to the non-volatile memory included in the MCU. This greatly reduces time required to mount the program to the MCU after completing the program. Further, by using a flash memory capable of rewriting data as non-volatile memory, the customer program once written can be rewritten, enabling to flexibly respond to fixing a bug after product shipment.

The non-volatile memory embedded MCU facilitates to write the customer program to the MCU without limitation of location. On the other hand, an importance of security control for writing the customer program is increasing.

For example when a MCU manufacturer receives a customer program from a customer to write the customer program to the non-volatile memory embedded in a MCU, the MCU manufacturer is required to prevent the customer program from leaking to a third party. An example of security countermeasure conventionally taken in such case is described hereinafter in detail with reference to FIG. 7.

In FIG. 7, 71 refers to an environment (hereinafter referred to as a customer environment) a customer manages, and 72 refers to an environment of the MCU manufacturer (hereinafter referred to as a writing environment) that the customer program is written therein. The customer encrypts the customer program using an encrypting apparatus 91 in the customer environment 71. The encrypting apparatus 91 encrypts a customer program AP using an encryption key CA being input and outputs an encrypted program EAP1. The encryption key CA is an encryption key of a common key cryptography used in common for an encryption and decryption of data.

The encryption key CA is transferred from the customer environment 71 to a writing environment 72 via a path 31. Further, the encrypted customer program EAP1 is transferred to the writing environment 72 via a path 32. The paths 31 and 32 may be offline paths such as parcel delivery service besides communication network as long as certain credibility is secured. For example if the path 31 is internet, the customer and the MCU manufacturer may exchange the encryption key CA according to a predetermined encryption format.

The encrypted program EAP1 transferred to the writing environment 72 is decrypted by a decrypting apparatus 92. The decrypting apparatus 92 inputs the encryption key CA and the encrypted customer program EAP1, and then outputs the decrypted customer program AP. The decrypted customer program AP is input to a MCU 80 having a non-volatile memory by the writing apparatus (not shown) such as a LSI tester and a flash memory writer. The customer AP input to the MCU 80 is written to a non-volatile memory 82 by a CPU (Central Processing Unit) 81.

Specifically, the writing process of the customer program AP is accomplished by the CPU 81 reading out a writing program describing a procedure to write the customer program to the non-volatile memory 82 from a firmware ROM (not shown) included in the MCU 80 to execute the writing program.

By writing the customer program with the configuration of FIG. 7, it is possible to prevent the customer program from leaking to the third party while transferring the customer program. However it has been discovered that there still is possibility that the customer program leaks to the third party while in the writing environment 72 because a non-encrypted customer program AP is placed in the writing environment 72.

A microcomputer inputting an encrypted application program and an encryption key for decrypting the encrypted application program so as to decrypt the application program by an encryption key input externally is disclosed in Japanese Unexamined Patent Application Publication No. 11-282667. The encryption key for decrypting the application program is input to the microcomputer, where the encryption key is encrypted by a public key corresponding to a private key of a public key cryptography that is stored to the microcomputer.

As described in the foregoing, a risk of leaking a program is high in writing the program to a non-volatile memory embedded in a microcomputer.

### SUMMARY OF THE INVENTION

According to first aspect of the present invention, there is provided a microcomputer that includes a first non-volatile storage unit, a first input terminal configured to input first key data, a second storage unit configured to store second key data that is different from the first key data, a second input terminal configured to input an encrypted program, a decrypting unit configured to decrypt the encrypted program using the first and the second key data, and a central processing unit configured to control storing a decrypted program decrypted by the decrypting unit to the first storage unit.

According to such configuration, a customer program stored to the non-volatile storage unit embedded in the microcomputer is input to the microcomputer with the customer program stored is encrypted by the first and the second keys. This eliminates the needs to place a non-encrypted program in the writing environment, thereby reducing risk of leaking the customer program to a third party.

In the microcomputer of the first aspect, the second key, which is one of the encryption keys necessary to decrypt the customer program, is stored to the microcomputer in advance. Therefore only with the encryption key (the first key) input to the microcomputer together with the encrypted program cannot decrypt the customer program. Accordingly this further reduces the risk of leaking the customer program to the third party.

According to second aspect of the present invention, there is provided a method of writing a program to a first non-volatile storage unit embedded in a microcomputer. To be more specific, first key data and an encrypted program are input to the microcomputer. Then the encrypted program is decrypted using the first key data input to the microcomputer and second key data stored to a second storage unit included in the microcomputer. The second key data is different from the first key data. Lastly the decrypted program is stored to the first storage unit.

According to third aspect of the present invention, there is provided a computer program product for directing a central processing unit included in a microcomputer to execute a program writing process to a first non-volatile storage unit included in the microcomputer. The program writing process includes inputting first key data to the microcomputer, inputting an encrypted program to the microcomputer, decrypting the encrypted program using the first key data input to the microcomputer and second key data previously stored to a second storage unit included in the microcomputer and is different from the first key data, and storing the decrypted program to the first storage unit.

The present invention reduces a risk of program leaking in writing a program to a non-volatile memory embedded in a microcomputer.

### BRIEF DESCRIPTION OF THE DRAWINGS

The above and other objects, advantages and features of the present invention will be more apparent from the following description taken in conjunction with the accompanying drawings, in which:

FIG. 1 is a configuration diagram of a program writing system according to the present invention;

FIG. 2 is a flowchart illustrating a storage process of an encryption key to a microcontroller unit according to the present invention;

FIG. 3 is a configuration diagram of the microcontroller unit according to the present invention;

FIG. 4 is a flowchart illustrating a process of the microcontroller unit according to the present invention;

FIG. 5 is a configuration diagram of the program writing system according to the present invention;

FIG. 6 is a flowchart showing a comparison process of signature data according to the present invention; and

FIG. 7 is a view explaining a program writing process according to a conventional technique.

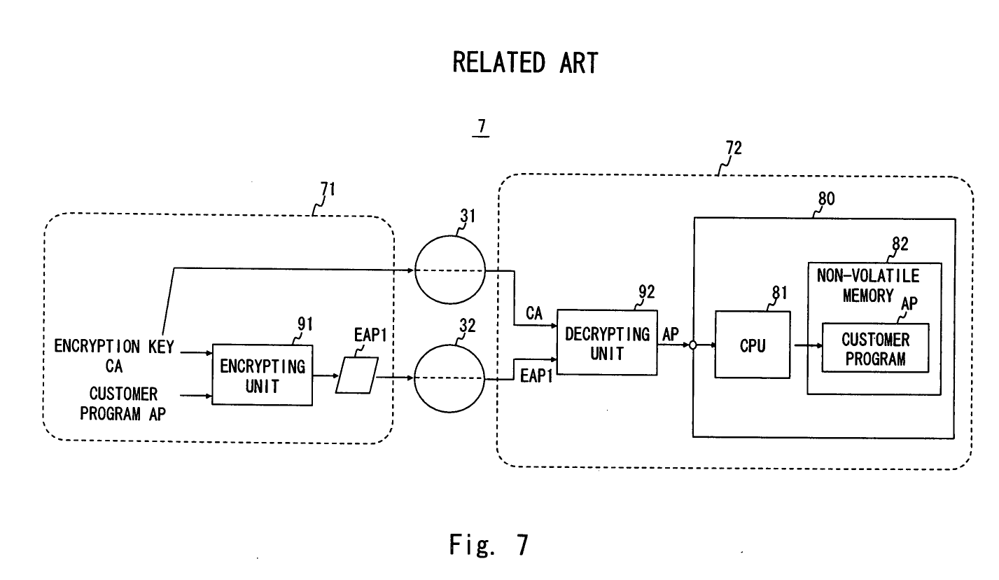

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. In the drawings, components identical to those therein are denoted by reference numerals with repeated explanation omitted as necessary for clarity of the explanation.

### First Embodiment

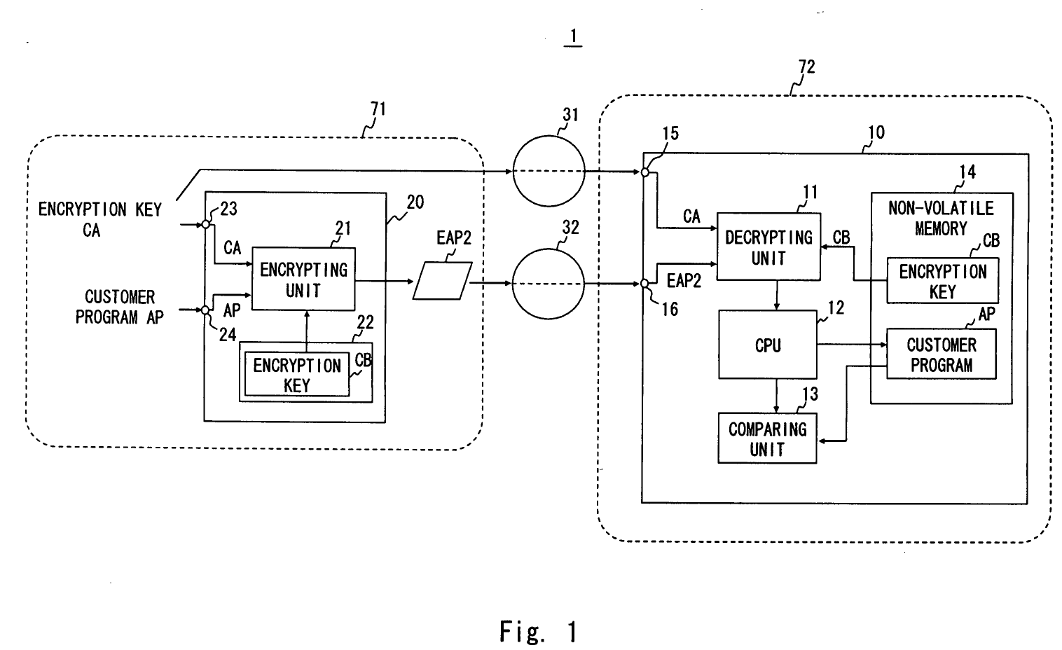

A configuration of a program writing system according to this embodiment is shown in FIG. 1. The program writing system 1 includes an encrypting apparatus 20 in the customer environment 71 and a MCU 10 placed in the writing environment 72.

The encryption apparatus 20 includes an encrypting unit 21 for encrypting a customer program AP input using encryption keys CA and CB. Further, the encryption apparatus 20 includes a non-volatile memory 22 for storing the encryption key CB. The encryption keys CA and CB are encryption keys of a common key cryptography used in common for an encryption and a decryption of data.

The encrypting unit 21 encrypts the customer program AP input externally via an input terminal 24 using the encryption key CA input externally via an input terminal 23 and the encryption key CB read from the non-volatile memory 22, and then outputs an encrypted customer program EAP2. Various algorithms may be applied to an encryption algorithm that uses the two encryption keys CA and CB of the common key cryptography. For example when using a triple DES (Data Encryption Standard) algorithm, a first DES encryption may be performed by the encryption key CA, a second DES decryption may be performed by the encryption key CB, and a third DES encryption may be performed by the encryption key CA. Other block encryption algorithms besides DES such as AES (Advanced Encryption Standard) and stream encryption algorithms such as RC4 may be applied.

The non-volatile memory 22 is maintained in a way the encryption key CB cannot be read from outside of the encrypting apparatus 20. Specifically, after writing the encrypting key CB to the non-volatile memory 22 before using the encrypting apparatus 20, accesses to the non-volatile memory 22 from outside of the encrypting apparatus 20 should not be allowed.

The customer program EAP2 encrypted by the encrypting apparatus 20 and the encryption key CA are transferred from the customer environment 71 to the writing environment 72 via paths 31 and 32. As described in the foregoing, the path 31 and 32 may be offline path such as parcel delivery service besides communication network as long as certain credibility is secured.

The MCU 10 inputs the encryption key CA via an input terminal 15 and inputs the encrypted customer program EAP2 via an input terminal 16. The input terminals 15 and 16 may physically be separate terminals or single common terminal.

The encryption key CA and the encrypted customer program EAP2 are input to a decrypting unit 11. The decrypting unit 11 decrypts the encrypted customer program EAP2 using the encryption key CA and the encryption key CB read out from the non-volatile memory 14. Various algorithms using two encryption keys CA and CB of the common key cryptography may be applied to a decryption algorithm applied to the decrypting unit 11. For example encryption algorithms including a triple DES, AES, and EC4 may be applied as with the encrypting unit 21.

A CPU (Central Processing Unit) 12 reads out the customer program AP stored to the non-volatile memory 14 to execute it. The CPU 12 controls a process to write the customer program AP decrypted by the decrypting unit 11 to the non-volatile memory 14. Specifically the CPU 12 includes a temporary storage region (not shown) for storing up data encrypted by the decrypting unit 11. In the block encryption algorithm, the CPU 12 stores by each encrypting block, whereas in the stream encryption algorithm, the CPU 12 stores by each bit, the data output from the decrypting unit 11 in the temporary storage region. The CPU 12 aligns the temporary stored data by writing unit for the non-volatile memory 14 to perform a writing to the non-volatile memory 14.

A comparing unit 13 reads out data written to the non-volatile memory 14 by the CPU 12 with the data temporary stored to the CPU 12. If a result of the data comparison indicates the data are equivalent, the comparing unit 13 evaluates as a successful writing, while if a result of the data comparison indicates the data are not equivalent the comparing unit 13 evaluates as an unsuccessful writing. This enables to verify the writing of the customer program AP by the CPU 12 to the non-volatile memory 14.

The result of the data comparison evaluated as not equivalent in the comparing unit 13 and evaluated as an unsuccessful writing, preferably the result of the evaluation is notified to the CPU 12, and the CPU 12 receiving the notification deletes data in a region not succeeded in writing to the non-volatile memory 14 so as to write data again.

The non-volatile memory 14 stores the encryption key CB in advance. The encryption key CB is maintained in a way the encryption key CB cannot be read from outside of the MCU 10. Specifically, after writing the encryption key CB to the non-volatile memory 14 before using the MCU 10, accesses to the region storing the encryption key CB in the non-volatile memory 14 from outside of the decrypting unit 11 should not be allowed.

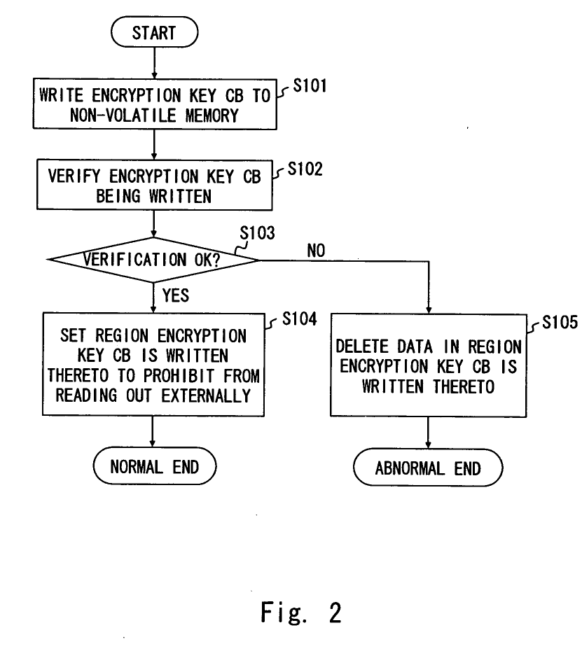

A procedure of writing the encryption key CB is described hereinafter in detail with reference to FIG. 2. In step S101, the encryption key CB is written to the non-volatile memory 14. In step S102, the encryption key CB written to the non-volatile memory 14 is read out and compared with the original encryption key CB so as to verify whether the writing is successfully performed. If the writing of the encryption key CB is successfully performed, an read access to the region in which the encryption key CB is written thereto in the non-volatile memory 14 from outside of the decrypting unit 11 is set to be prohibited (steps S103 and S104).

If writing of the encryption key CB is evaluated as unsuccessful, the data in a region in which the encryption key CB is written thereto in the non-volatile memory 14 is deleted (steps S103 and S105). After deleting the data in S105, processes after S101 are executed again to complete writing the encryption key CB to the non-volatile memory 14.

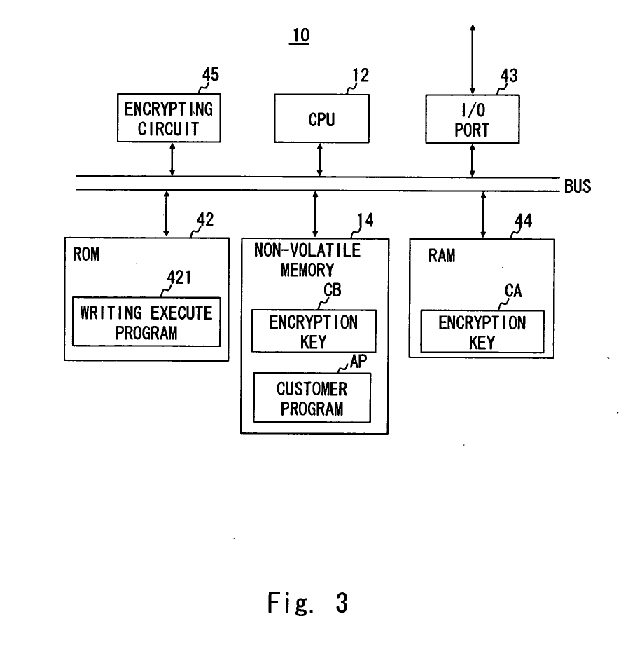

Not only the process of writing the customer program AP to the non-volatile 14 but the processes executed by the decrypting unit 11 and the comparing unit 13 may specifically be accomplished by executing a firmware program by the CPU 12. A specific configuration of the MCU 10 is shown in FIG. 3. The MCU 10 shown in FIG. 3 is a microcomputer integrating the CPU 12, a ROM 42, a RAM 44, and the non-volatile memory 14 into one IC package to form a chip.

In FIG. 3, the CPU 12 reads out a writing execute program 421 stored to the ROM 42 and the customer program AP stored to the non-volatile memory 14 to execute commands. The ROM 42 is a memory storing a firmware program such as the writing execute program 421.

An I/O port 43 is an input/output interface of the MCU 10. The input terminals 15 and 16 correspond to the I/O port 43.

The RAM 44 is a volatile storage area used as a working area of the CPU 12. The RAM 44 is used as a storage region of the encryption key CA and the encrypted customer program EAP2 input via the I/O port 43 and the temporary storage unit of the decrypted customer program AP.

An encrypting circuit 45 reads the encryption key CB from the non-volatile memory 14 according to a control of the CPU 12 and the encryption key CA and the encrypted customer program EAP2 from the RAM 44 to decrypt the customer program EAP2. The encrypting circuit 45 executes a decrypting process corresponding to the decrypting unit 11. The decrypting process corresponding to the decrypting unit 11 may be accomplished by storing a decrypting program (not shown) describing a decrypting procedure to the ROM 42 and the CPU 12 executing the decrypting program. At this time the decrypting program is a different program module from the writing execute program 421. The decrypting program may be read out from the writing execute program 421. The decrypting program may be one program same as the writing execute program 421.

The writing execute program 421 is a program for accomplishing functions of the decrypting unit 11, the CPU 12, and the comparing unit 13. Specifically the functions of the decrypting unit 11, the CPU 12, and the comparing unit 13 are accomplished by the CPU 12 of FIG. 3 executing the writing execute program 421 and cooperates with the RAM 44, the I/O port 43, the encrypting circuit 45, and the non-volatile memory 14 etc.

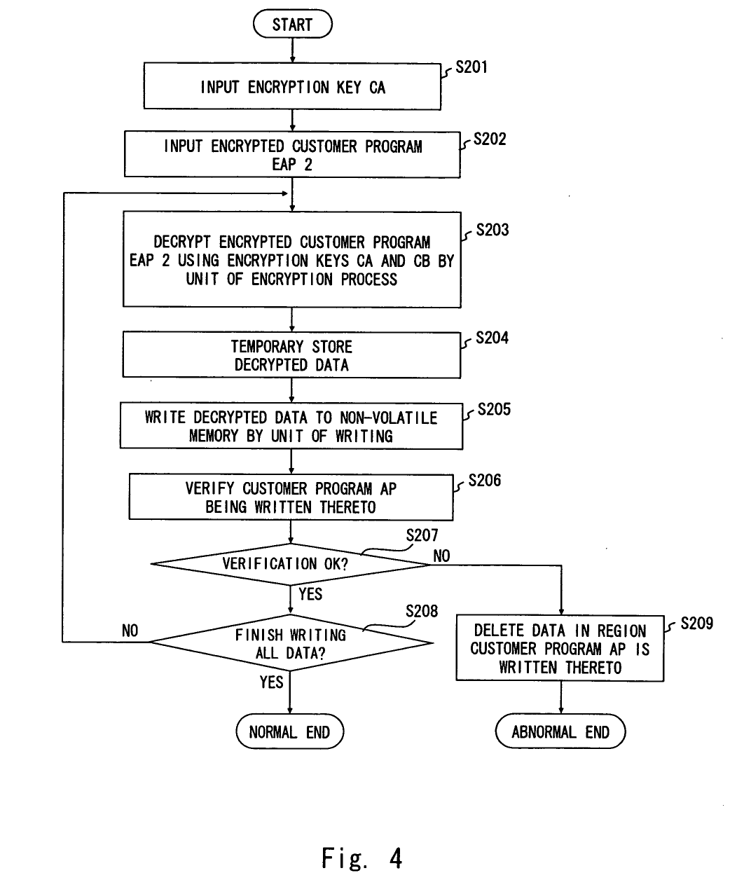

A process flow of the MCU 10 according to the writing execute program 421 is shown in FIG. 4. In step S201, the encryption key CA is input via the I/O port 43 and stored to the RAM 44. In step S202, the encrypted customer program EAP2 is input via the I/O port 43 and stored to the RAM 44.

In step S203, the encryption key CA stored to the RAM 44 in step S201 and the encryption key CB stored to the non-volatile memory 14 in advance are read out. Further, the program EAP2 is decrypted using the two encryption keys CA and CB. The decryption process of the program EAP2 is executed by reading out the program EAP2 stored to the RAM 44 by each encryption process data.

In step S204, the data decrypted by the encrypting circuit 45 is temporary stored to the RAM 44. In step S205, the decrypted data temporary stored to the RAM 44 is read out by each writing unit of the non-volatile memory 14 so as to write the data to the non-volatile memory 14.

In step S206, the customer program AP written to the non-volatile memory 14 is verified. Specifically, the data written to the non-volatile memory 14 is read out, and the read data is compared with the data temporary stored to the RAM 44 in step S204. This is how the verification of the customer program AP whether it has successfully been written is performed. In case of a successful writing, the process returns to the step S203 to perform decryption, writing, and verification of next data (step S207). On a completion of decryption, writing, and verification of all data in the encrypted customer program EAP2, the writing process flow is ended (step S208).

On the other hand, in case of an unsuccessful writing to the non-volatile memory 14 in the verification of the step S206, data in a region of the unsuccessful writing is deleted (step S209). After deleting the region of the unsuccessful writing, it is preferable to write the decrypted data again.

The processes of the steps S201 to 203 correspond to the process of the decrypting unit 11. Further, the processes of the steps S206, S207, and S209 correspond to the process of the comparing unit 13.

A location to store the writing execute program 421 is not limited to the ROM 42 but may be stored to any kinds of storage medium including the non-volatile memory 14. The writing execute program 421 may be transmitted via a communication medium. The storage medium here includes for example a flexible disk, hard disk, magnetic disk, magnetic optical disk, CD-ROM, DVD, and RAM memory cartridge with battery backup. The communication medium includes a cable communication medium such as a telephone line, radio communication medium such as a microwave line, and internet.

As described in the foregoing, the program writing system 1 inputs the customer program EAP2 encrypted by the encryption keys CA and CB into the MCU 10, decrypts the customer program EAP2 inside the MCU 10, and then writes the customer program AP to the non-volatile memory 14. The non-encrypted customer program AP is not placed in the writing environment 72 in this way, thereby preventing the customer program AP from leaking in the writing environment 72 to a third party.

The program writing system 1 of this embodiment encrypts the customer program AP using the two encryption keys CA and CB of the common key cryptography. An amount of decrypting operation in the common key cryptography is known to be smaller than an amount of decrypting operation in the public key cryptography. This is because that the decryption operation in the common key cryptography is performed by simply bit permutation operations and EXOR operations, whereas the decryption operation in the public key cryptography requires a huge amount of exponentiation operations and division operations. Accordingly the MCU 10 performing the decryption in the common key cryptography requires less amount of operation as compared to the decryption in the public key cryptography. Thus the MCU 10 does not require a high performance encryption circuit as required to perform a decryption process in the public key cryptography but an encryption circuit having low processing capability may be used. This enables to reduce cost and suppresses from enlarging a circuit size. To perform the decryption process using the encryption keys CA and CB by the CPU 12 embedded in the MCU 10, it is possible to accomplish it by the CPU 12 having relatively lower processing capability (for example an 8 bits CPU that processes only 8 bits data in one process) than in the decryption process in the public key cryptography.

There are following advantages by performing the encryption of the customer program AP using the encryption keys CA and CB of the common key cryptography. For a comparison with this embodiment, a case of encrypting the customer program AP by one encryption key, which is CB, to transfer the encrypted program between the customer environment 71 and the writing environment 72 is considered hereinafter. In this case, there is a problem that the encrypted customer program may be leaked to the third party for some reason, and if the third party obtains an encrypting apparatus, the third party is able to decrypt the customer program AP. This is because that in the encryption algorithm such as DES, which is the common key cryptography, inputting the encrypted customer program to the encrypting apparatus for encrypting by the encryption key CB enables to obtain a decrypted customer program.

On the other hand in the program writing system 1 of this embodiment, even when the third party obtains the encrypted customer program EAP2 and the encrypting apparatus, the third party will not be able to obtain the decrypted customer program AP unless obtaining the encryption key CA. Thus it is possible to prevent the customer program AP from leaking to the third party. The encryption key CA input to the encrypting apparatus 20 and the MCU 10 is preferably different between each customer or customer program. Specifying a different combination of the encryption keys CA and CB by each customer or customer program efficiently prevents the customer program AP from leaking to the third party.

The encryption key CB cannot be read from outside of the encrypting apparatus 20 and the MCU 10 of this embodiment. Therefore, if the encrypted customer program EAP2 and the encryption key CA are leaked to the third party for some reason, the third party will not be able to decrypt the encrypted customer program EAP2 to obtain the customer program AP.

### Second Embodiment

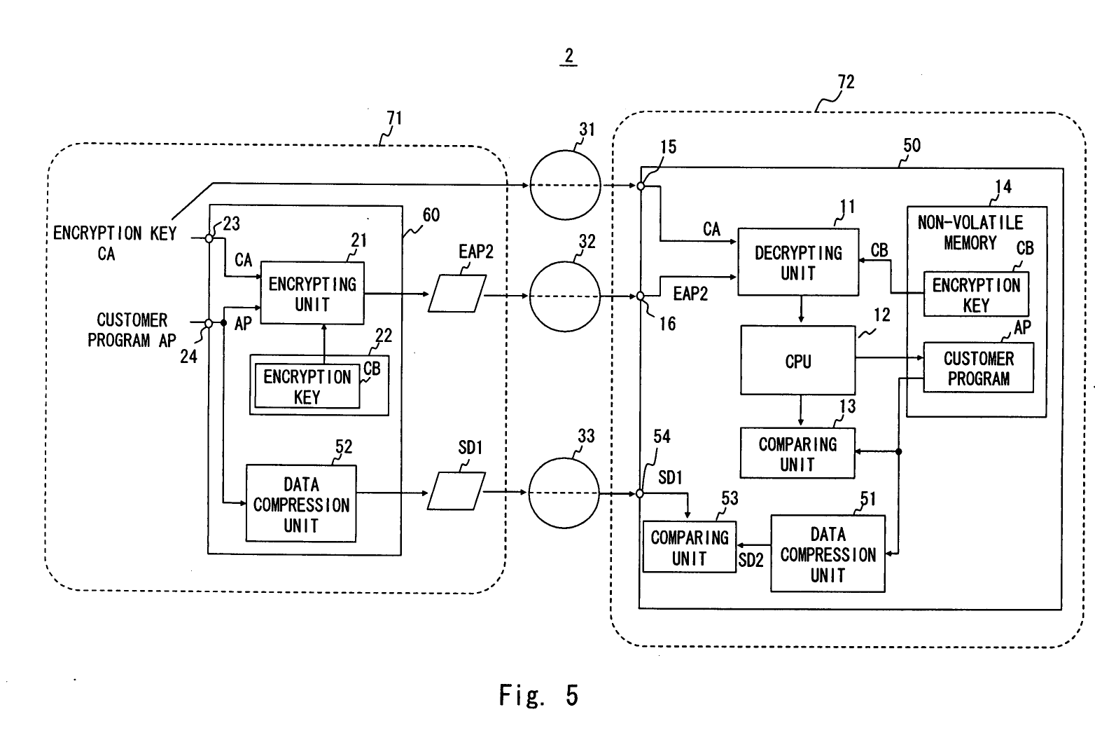

A configuration of a program writing system 2 is shown in FIG. 5. The program writing system 2 includes an encrypting apparatus 60 placed in the customer environment 71 and a MCU 50 placed in the writing environment 72.

The encrypting apparatus 60 is different from the encrypting apparatus 20 of the first embodiment that the encrypting apparatus 60 includes a data compression unit 52. Other components of the encrypting apparatus 60 are identical to the components of the encrypting apparatus 20 shown in FIG. 1. Components identical to those in the encrypting apparatus 20 of FIG. 1 are denoted by reference numerals identical to those therein with detailed description omitted.

The data compression unit 52 performs a lossy compression to the customer program AP to generate the signature data SD1. Signature data SD1 needs to be generated so that a same value is supplied if the original customer program is same, and a different value is supplied if the original customer program is different. Accordingly a certain hash function is used to calculate a hash value from the customer program AP, and the obtained has value may be the signature data SD1. The hash value of the signature data SD1 may be calculated from an entire customer program AP or from a part of data included in the customer program AP.

The signature data SD1 generated by the encrypting apparatus 60 is sent to the writing environment 72 via the path 33. The path 33 may be offline path such as parcel delivery service besides communication network. The path 33 may be a same path as the paths 31 and 32.

The MCU 50 is different from MCU 10 of the first embodiment that the MCU 50 includes the data compression unit 51 and the comparing unit 53. Other components besides the MCU 50 are identical to the components of the MCU 10 shown in FIG. 1. Components identical to those in the MCU 10 of FIG. 1 are denoted by reference numerals identical to those therein with detailed description omitted.

The data compression circuit 51 generates signature data SD2 from the customer program AP decrypted by the decrypting unit 11 in the same procedure as the data compression unit 52. To be more specific, the same hash function of the data compression unit 52 is used to calculate a hash value from the customer program AP stored in the non-volatile memory 14, and the obtained hash value may be the signature data SD2.

The comparing unit 53 compares the signature data SD1 input via an input terminal 54 with the signature data SD2 generated by the data compression unit 51 to evaluate whether the data are equivalent. The evaluation verifies a consistency of a combination of the encryption key CA and the customer program AP. That is, the signature data being equivalent indicates that the decryption using the encryption key CA is properly performed, in other words, the combination of the encrypted customer program EAP2 and the encryption key CA is correct. On the other hand the signature data being not equivalent indicates that the decryption using the encryption key CA is not properly performed, in other words, the combination of the encrypted customer program EAP2 and the encryption key CA is not correct.

The MCU 10 of the first embodiment inputs the encrypted customer program EAP2 and the encryption key CA to the MCU 10 to decrypt the customer program EAP2 to obtain the customer program AP inside the MCU 10. By inputting a wrong combination of the encrypted customer program EAP2 and the encryption key CA to the MCU 10, data obtained after decrypting will be different from the original customer program AP. Thus wrong data is written to the non-volatile memory 14.

In such case that a selection of the encryption key CA was wrong and wrong data was written to the non-volatile memory 14, the comparing unit 13 is not able to detect the abnormality. That is, the combination of the encrypted customer program EAP2 and the encryption key CA cannot be verified. Further, the original customer program AP does not exist in the writing environment 72. Therefore, it is difficult to guarantee the validity of the combination of the encrypted customer program EAP2 and the encryption key CA in the writing environment 72 where the MCU 10 is placed.

On the other hand in the MCU 50 of this embodiment, it is possible to verify whether the decryption process is successfully performed using the correct encryption key CA by the comparison of the signature data in the comparing unit 53. As the MCU 50 is able to verify the successful decryption process using the comparing unit 53, and also to verify the successful writing process using he comparing unit 13, credibility for writing the customer program AP to the non-volatile memory 14 can further be improved.

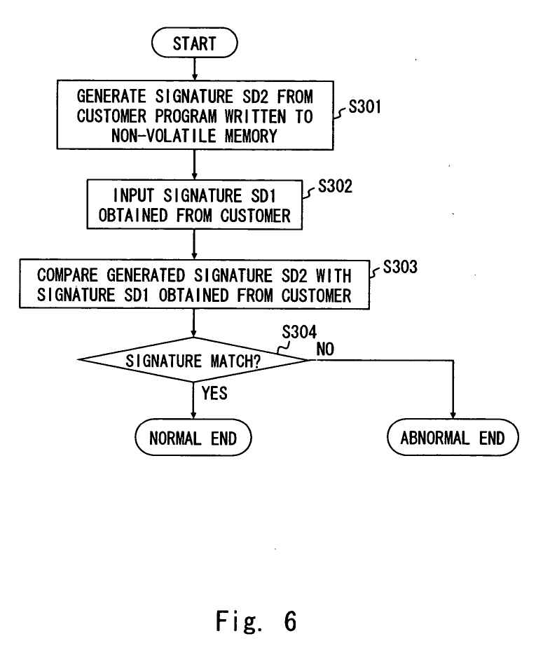

A procedure of comparing the signature data by the data compression unit 51 and the comparing unit 53 is described hereinafter with reference to a flowchart of FIG. 6. In step S301, the data compression unit 51 generates the signature data SD2 from the customer program AP written to the non-volatile memory 14 by the CPU 12 to output the signature data SD2 to the comparing unit 53.

In step S302, the signature data SD1 sent from the customer environment 71 is input to the comparing unit 53 via the input terminal 54. In step S303, the comparing unit 53 compares the signature data SD2 with the signature data SD1.

If the signature data SD1 and SD2 is equivalent as a result of the comparison in the step S303, the verification is ended evaluating that the combination of the encrypted customer program EAP2 and the encryption key CA is correct, and the decryption process is successfully performed (step S304). On the other hand if the signature data SD1 and SD2 is not equivalent, the verification is ended evaluating that the combination of the encrypted customer program EAP2 and the encryption key CA is wrong, and the decryption process is unsuccessfully performed (step S304). If evaluated that the decryption process is unsuccessfully performed, it is preferable that the customer program AP is stopped to be written to the non-volatile memory 14 and data already written is deleted. This is to stop wrong writing and to discard wrong data.

The MCU 50 can be accomplished by the specific configuration of FIG. 3. Specifically, the functions of the MCU 50 of this embodiment can be accomplished by the processes of the data compression unit 51 and the comparing unit 53 being described in a firmware program similar to the writing execute program 421 of FIG. 2, and the CPU 12 executing the processes. The data compression unit 51 and the comparing unit 53 may be disposed as exclusive process circuits separated from the CPU 12.

### Other Embodiments

The MCU 50 of the second embodiment includes the comparing unit 53 and performs the comparison of the signature data inside the MCU 50. However the signature data SD2 generated in the data compression unit 51 may be output outside the MCU 50 and the comparison of the signature data SD1 and SD2 may be performed outside the MCU 50.

In the MCU 50 of the second embodiment, the comparing unit 13 may be removed and comparing signature data by the comparing unit 53 to verify a successful writing of the program.

In the second embodiment, the signature data SD1 and SD2 may be configured to be generated from data combining the customer program AP and the encryption key CA.

In the comparing unit 13 of the first and the second embodiment, a successful writing may be verified by comparing data that is re-encrypted of the customer program AP read out from the non-volatile memory 14 using the encryption keys CA and CB with the encrypted customer program EAP2 input from the input terminal 16. Further, the successful writing may be verified by re-encrypting the customer program AP read out from the non-volatile memory 14 using the encryption keys CA and CB to output the re-encrypted customer program outside the MCU 10 or 50, and comparing the re-encrypted customer program with the encrypted customer program EAP2 outside the MCU 10 or 50.

In the MCUs 10 and 50 of the first and the second embodiment, the encryption key CB is to be stored to the non-volatile memory 14 where the customer program AP is stored. However the location to store the encryption key CB is not limited to the non-volatile memory 14 as long as it is a non-volatile storage area not accessible from outside of the MCUs 10 and 50.

The encrypting apparatuses 20 and 60 of the first and the second embodiment may be configured by a general purpose computer system. In this case it is not necessary to store the encryption key CB in a way the encryption key CB cannot be read from outside of the encrypting apparatus 20. However the encrypting apparatuses 20 and 60 are preferably configured to be exclusive for encrypting programs written to the MCUs 10 and 50, and the encryption key CB cannot be read from outside of the encrypting apparatuses 20 and 60. This facilitates the management of the encryption key CB.

The program writing systems 1 and 2 of the first and the second embodiment use the encryption keys CA and CB of the common key cryptography in this example. However an asymmetric key cryptography such as the public key cryptography may be used where a key for encryption is different from a key for decryption. In such case the program writing system may be configured as in the following example. Firstly two pairs of keys of the asymmetric key cryptography are prepared. One of the pairs includes an encryption keys CA1 and CA2. Another pair includes an encryption keys CB1 and CB2. Data encrypted by the encryption key CA1 can be decrypted only by the encryption key CA2. Data encrypted by the encryption key CB1 can be decrypted only by the encryption key CB2. Once such key pairs are prepared, then the encryption keys CA and CB used for encrypting the customer program AP in the encrypting apparatuses 20 and 60 are replaced with the encryption keys CA1 and CB1 respectively. On the other hand the two encryption keys CA and CB used for decryption of the encrypted customer program EAP in the MCUs 10 and 50 are replaced by the encryption keys CA2 and CB2 respectively. This enables to use encryption keys of the asymmetric key cryptography.

It is apparent that the present invention is not limited to the above embodiments and it may be modified and changed without departing from the scope and spirit of the invention that includes writing systems and computer program products indicated below.

AA. A writing system for writing a program to a first non-volatile storage unit embedded in a microcomputer comprising:
an encrypting apparatus configured to encrypt a pre-encrypted program; and
a microcomputer configured to decrypt an encrypted program by the encrypting apparatus,
   wherein the encrypting apparatus comprises:
a first input terminal configured to input first key data;
a first storage unit configured to store second key data different from the first key data;
a second input terminal configured to input the pre-encrypted program; and
an encrypting unit configured to encrypt the pre-encrypted program using the first and the second key data,

wherein the microcomputer comprises:
a second non-volatile storage unit
a third input terminal configured to input third key data;
a third storage unit configured to store fourth key data, the fourth key data being different from the third key data, the third storage unit prohibited of reading out the fourth key data from outside the microcomputer;
a fourth input terminal configured to input the encrypted program;
a decrypting unit configured to decrypt the encrypted program using the third and the fourth key data; and
a central processing unit configured to control storing a decrypted program decrypted by the decrypting unit to the second storage unit.

BB. The writing system according to the system AA, wherein the first and the third key data are equivalent, and the second and the fourth key data are equivalent.

CC. A computer program product for directing a central processing unit included in a microcomputer to execute a program writing process to a first non-volatile storage unit included in the microcomputer, wherein the program writing process comprises:

inputting first key data to the microcomputer;

inputting an encrypted program to the microcomputer;

decrypting the encrypted program using the first key data input to the microcomputer and second key data previously stored to a second storage unit included in the microcomputer, the second key data is different from the first key data; and

storing the decrypted program to the first storage unit.

DD. The computer program product according to the product CC, wherein the first and the second key data are used in common for encrypting and decrypting data; and

the encrypted program is encrypted using both of the first and the second key data.

EE. The computer program product according to the product CC, wherein the writing process further comprises:

generating first signature data by compressing the decrypted program; and

comparing the first signature data with second signature data, the second signature data is generated by compressing data before encrypting the encrypted program by same generation rule of the first signature data.

FF. The computer program product according to the product EE, wherein the first and the second signature data are a hash value.

What is claimed is:

1. A microcomputer comprising:
a first non-volatile storage unit;
a first input terminal configured to input first key data;
a second storage unit configured to store second key data, the second key data being different from the first key data;
a second input terminal configured to input an encrypted program;
a decrypting unit configured to decrypt the encrypted program using the first and the second key data; and
a central processing unit configured to control storing a decrypted program decrypted by the decrypting unit to the first storage unit.

2. The microcomputer according to claim 1, wherein the first and the second key data are used in common for encrypting and decrypting data, and
the encrypted program input to the second input terminal is encrypted using both of the first and the second key data.

3. The microcomputer according to claim 1, wherein the second storage unit is non-volatile.

4. The microcomputer according to claim 1, wherein the second storage unit stores the second key data in a way the second key data cannot be read from outside of the microcomputer.

5. The microcomputer according to claim 1, further comprising a data compression unit configured to compress the decrypted program to generate signature data.

6. The microcomputer according to claim 5, further comprising a signature comparing unit configured to match the signature data generated by the data compression unit with signature data input externally.

7. The microcomputer according to claim 5, wherein the signature data is a hash value generated from the decrypted program.

8. The microcomputer according to claim 6, wherein the signature data is a hash value generated from the decrypted program.

9. The microcomputer according to claim 1, wherein the first key data is an encryption key specific to the encrypted program.

10. The microcomputer according to claim 1, wherein the decrypting unit decrypts the encrypted program using the first and the second key data in triple DES.

11. The microcomputer according to claim 1, wherein the first and the second input terminals are single common terminal.

12. A method of writing a program to a first non-volatile storage unit embedded in a microcomputer, the method comprising:
inputting first key data to the microcomputer;
inputting an encrypted program to the microcomputer;
decrypting the encrypted program using the first key data input to the microcomputer and second key data previously stored to a second storage unit included in the microcomputer, the second key data being different from the first key data; and
storing the decrypted program to the first storage unit.

13. The method according to claim 12, wherein the first and the second key data are used in common for encryption and decryption of data, and
the encrypted program is encrypted using both of the first and the second key data.

14. The method according to claim 12, further comprising:
generating first signature data by compressing the decrypted program; and
comparing the first signature data and second signature data, the second signature data is generated by compressing data before encrypting the encrypted program by same generation rule of the first signature data.

15. The method according to claim 14, wherein the first and the second signature data are a hash value.

16. The method according to claim 12, wherein accesses to the second storage unit is prohibited from reading from outside of the microcomputer, and
the method according to claim 12 is executed by the microcomputer.

17. An encrypting apparatus comprising:
a first input terminal configured to input first key data;
a first storage unit configured to store second key data, the second key data being different from the first key data;
a second input terminal configured to input a program; and
an encrypting unit configured to encrypt the program using the first and the second key data.

18. The encrypting apparatus according to claim 17, further comprising a data compression unit configured to generate signature data by compressing the program.
